(19) United States
(12) Patent Application Publication
(10) Pub. No.: US 2006/0259690 A1
(43) Pub. Date: Nov. 16, 2006

(54) Methods and system for prepositioning frequently accessed web content

(75) Inventors: Mahesh Vittal, Villivakkam (IN); Srinivasan Santhanam, Adyar (IN); Kumar Thiagarajan, West Mambalam (IN); Suresh Pachiappan, Kotturpuram (IN)

Correspondence Address: Trellis Intellectual Property Law Group, PC, 1900 EMBARCADERO ROAD, SUITE 109, PALO ALTO, CA, 94303, US

(73) Assignee: Cisco Technology, Inc., San Jose, CA (US)

(21) Appl. No.: 11/125,464

(22) Filed: May 10, 2005

(51) Int. Cl. G06F 12/00

(52) U.S. Cl. 711/118

(57) ABSTRACT

A method, system and apparatus for storage and distribution of content in a content delivery network (CDN) are provided. The method includes acquiring and storing popularly accessed content from a content engine's cache file system. The method further includes mechanisms that distribute the stored content in the persistent content delivery network file system to the CDN network.

### BACKGROUND OF THE INVENTION

1. Field of Invention

The embodiments of the invention relate in general to content delivery networks. More specifically, the embodiments of the invention relate to prepositioning of frequently accessed web content.

2. Description of the Background Art

Content delivery networks (CDNs) deliver web-based content from geographically dispersed servers that deliver content according to the proximity of a web surfer.

The nodes of a CDN include one or more content engines (CEs). Each CE is connected to multiple CEs in the CDN via a cache-enabled router. When a user makes a request for content from a particular address over the CDN, the cache-enabled router selects a CE to serve the request. This selection is based on an algorithm according to which a particular group of addresses is associated with each CE. The CE to which the request is re-routed ‘spoofs’ the requested address and accepts the request on its behalf via a standard Transport Control Protocol (TCP) connection established by the cache-enabled router. If the requested information is already stored in the CE, i.e., a cache hit takes place, it is transmitted to the requesting user. If the requested information is not in the CE, i.e., a cache miss takes place, the CE opens a direct TCP connection with the requested address, downloads the content, stores it for future use, and transmits it to the requesting user. The content is cached (stored) in a cache file system (CFS) of the CE.

The content caching described above provides a way of compensating for bandwidth limitations over the network. However, the success of content caching in compensating for bandwidth limitations corresponds directly to the efficiency with which the CEs operate. The CFS has a limited storage capacity. In addition, new content is constantly replacing the old content, which may lead to overwriting/deletion of certain content in the CFS.

### BRIEF DESCRIPTION OF THE DRAWINGS

FIG. 1 illustrates a block diagram of a content delivery network, wherein the invention can be practised, in accordance with various embodiments of the invention.

FIG. 2 is a flowchart illustrating a method for distribution of content in a content delivery network, in accordance with an embodiment of the invention.

FIG. 3 is a flowchart illustrating a method for acquiring content from a cache file system, in accordance with an embodiment of the invention.

### DETAILED DESCRIPTION OF EMBODIMENTS OF THE INVENTION

Embodiments of the invention provide a method, system, apparatus and machine-readable medium for storage and distribution of content in a content delivery network (CDN). The various embodiments of the invention enable storage and distribution of frequently accessed content. In various embodiments of the invention, the CDN includes one or more content engines (CEs) that are connected to each other. In various embodiments of the invention, the CE does caching as well as prepositioning. Caching involves storing frequently accessed content in a cache file system (CFS) of the CE. Prepositioning involves acquiring and distributing content, based on the concept of associating a set of contents, to a set of CEs. The content is prepositioned, based on predetermined criteria. The content to be prepositioned is acquired from the CFS and stored. In various embodiments of the invention, the acquired content is stored in a persistent content delivery network file system (CDNFS) storage. The stored content is subsequently distributed to other CEs connected over the CDN, making the stored content accessible to one or more users.

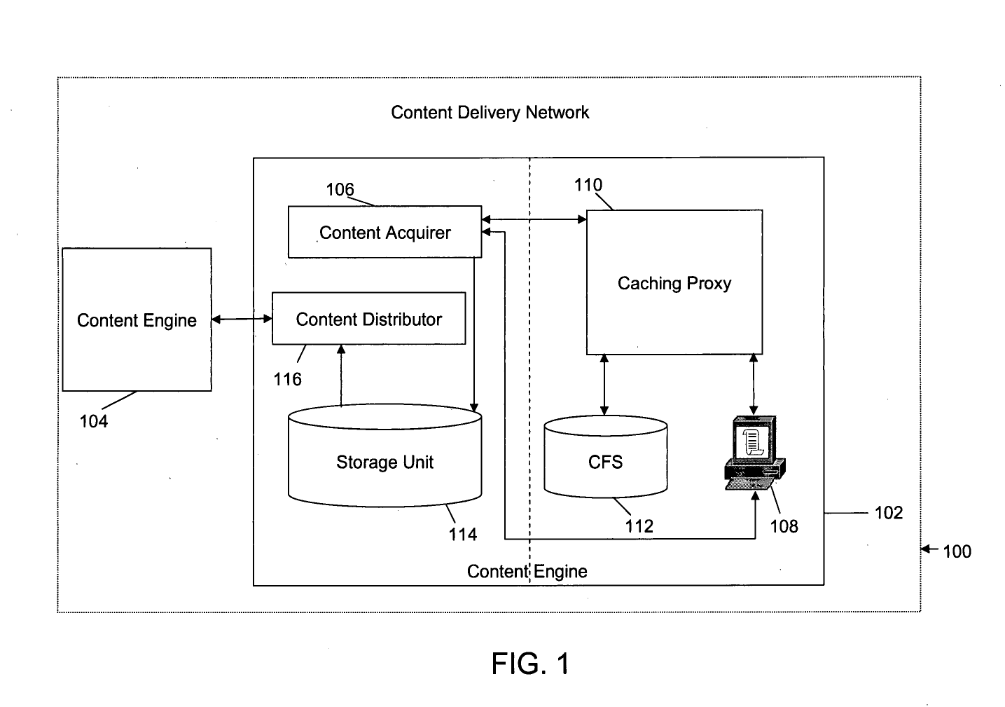

FIG. 1 depicts a Content Delivery Network (CDN) 100, wherein the various embodiments of the invention can be practised. CDN 100 includes a plurality of content engines (CEs) connected to each other. For example, as illustrated in FIG. 1, CDN 100 includes a content engine 102 and a content engine 104, in accordance with an embodiment of the invention. Content engine 102 includes a content acquirer 106, a logging server 108, a caching proxy 110, a caching file system 112, a storage unit 114, and a content distributor 116. In various embodiments of the invention, storage unit 114 is a persistent CDNFS storage.

Content acquirer 106 looks up logging server 108 to select content, based on predefined search criteria, and generates a list of contents that can be prepositioned. Once content acquirer 106 generates a list of contents that can be prepositioned, it issues a request to caching proxy 110 for each of them. In accordance with an embodiment of the invention, content acquirer 106 issues a request to caching proxy 110 for the cached content in cache file system 112.

Caching proxy 110 retrieves the content, to be prepositioned, from cache file system 112, and serves it to content acquirer 106. Content acquirer 106 pushes the content to storage unit 114 for storage. Subsequently, content distributor 116 pulls the content from storage unit 114 and distributes it to other CEs connected over the CDN (for example, content engine 104).

In various embodiments of the invention, system elements such as content acquirer 106, logging server 108, caching proxy 110, caching file system 112, storage unit 114, and content distributor 116 can be implemented in the form of software, hardware, firmware, or their combination thereof.

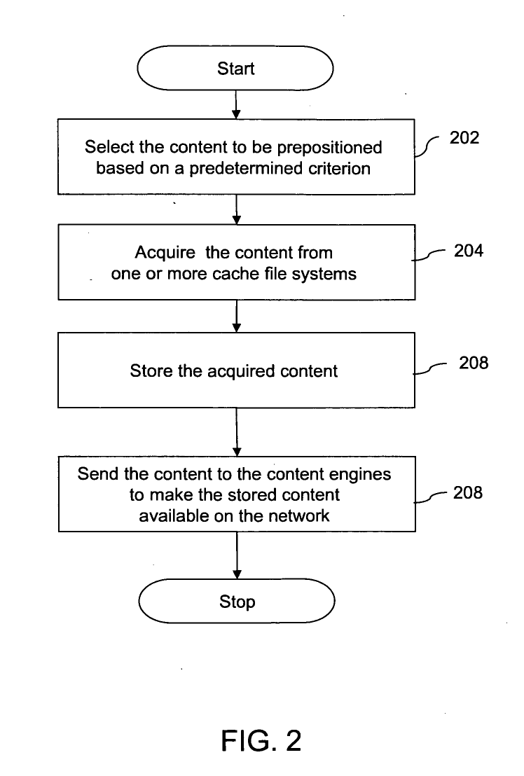

FIG. 2 is a flowchart illustrating a method for storing and distributing content in a content delivery network, in accordance with an embodiment of the invention. The content to be prepositioned is selected at step 202, based on a predefined criterion. The predefined search criterion may include the frequency with which the content is accessed in the network, its size, and the time that has lapsed since its last modification.

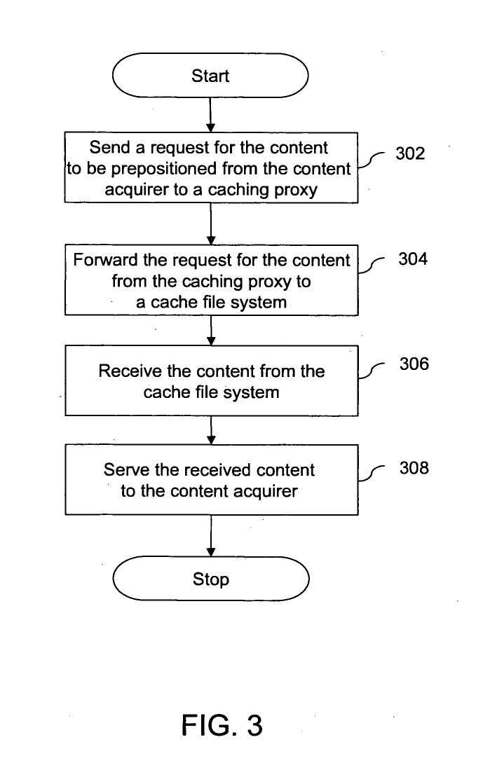

The content to be prepositioned is acquired at step 204 by content acquirer 106. The details pertaining to the acquisition of the content are explained in conjunction with FIG. 3.

The acquired content is stored at step 206. In various embodiments of the invention, the acquired content can be stored by using a persistent CDNFS storage. The file system used in the persistent CDNFS storage can be a general-purpose file system, in accordance with an embodiment of the invention. Examples of such file systems include ‘ext2’, which can be accessed by using standard system commands including open, read, write, etc.

The stored content is distributed at step 208 by using content distributor 116, in accordance with an embodiment of the invention. Content distributor 116 reads the stored content and sends it to other CEs in the CDN. In various embodiments of the invention, the mechanisms of sending the content to other CEs can include Internet Protocol (IP) Multicast or secure Transmission Control Protocol (TCP).

In accordance with an embodiment of the invention, the content to be prepositioned is selected, based on the frequency with which the content is accessed in the CDN. The mechanisms that can be used to determine the content that is frequently accessed include transaction logs and an Internet Caching Protocol (ICP) with a caching proxy.

Transaction logs can be created in a CE by keeping a record of all the requests served by the CE. These records can include the uniform resource locator (URL) that is requested, and details about the transaction between a user and the CE, and the CE and a server. The transaction log also indicates whether the request is a cache hit or a cache miss. Further, the transaction logs can be parsed, based on the access time, to generate a list of most frequently accessed contents in the last ‘n’ days. This provides a search space for getting the list of contents that are frequently accessed in the CDN. In an embodiment of the invention, a network administrator can predefine the number of days ‘n’.

In various embodiments of the invention, a CE can maintain a most recently used/least recently used (MRU/LRU) list of contents that is in its cache file system. The CE can use this as a mechanism to replace the content in the event of a shortage in the available storage space in the CFS. In an embodiment of the invention, internal Remote Procedure Calling (RPC) mechanisms can be used to fetch the details of the MRU/LRU list. These details are used to build the list of URLs that are most frequently accessed.

In accordance with an embodiment of the invention, CE 102 can include Application and Content Networking Software (ACNS). ACNS uses ‘Manifest files’, to specify the contents that are to be stored and distributed in CDN 100, based on predefined search criteria.

In an embodiment of the invention, Manifest files can be enhanced to preposition contents from cache file system 112, based on predefined search criteria. This search criterion can help to categorize the content and enable users to access the content with relevant publishing URLs. In an embodiment of the invention, the search criteria can be video files with extension ‘wmv’. Further, Manifest files can make use of the existing tags/include new tags, to specify content that can be pulled into the CDN network from cache file system 112.

In an embodiment of the invention, a Manifest file can be configured with the following tag:

<CdnManifest>

<crawler host=“WEB-CACHE” >

<matchRule>

<match url=“.*.asf” mimeType=“video” >

<matchRule>

</crawler>

</CdnManifest>

In another embodiment of the invention, a Manifest file can be configured in the following way:

<CdnManifest>
<crawler

start-url=“PATH OF FILE REPRESENTING THE SEARCH
SPACE”
isTranslog=“true” >
<!--isTranslog is true if the file referenced by
the start-url is a transaction log file -->
<match-rule>

<match extension=“jpg,gif,bmp”>
<match size-in-KB=“1024”>

</match-rule>

</crawler>
</CdnManifest>

FIG. 3 is a flowchart illustrating a method for acquiring content from a cache file system, in accordance with an embodiment of the invention. A request for the content to be prepositioned is sent to a caching proxy at step 302. This request is sent from content acquirer 106 to caching proxy 110, in accordance with an embodiment of the invention. Content acquirer 104 can conditionally send the request for the content. In accordance with an embodiment of the invention, content acquirer 104 sends the request only for the content that is previously cached in CFS 112. The request for the content is forwarded to the cache file system at step 304. In accordance with an embodiment of the invention, this request is forwarded to cache file system 112. Subsequently, at step 306, the content is received from cache file system 112. Thereafter, at step 308, the received content is served to content acquirer 106.

In an embodiment of the invention, cache file system 112 can be a circular file system in which the contents are stored contiguously with an assumption that the content size does not change.

In an embodiment of the invention, a read interface of the cache file system can be used to read the contents of cache file system 112.

In accordance with another embodiment of the invention, Hyper Text Transport Protocol (HTTP) can be used to read the contents of cache file system 112. HTTP helps to acquire the contents from cache file system 112. In this event, Manifest files are configured in the following way:

<CdnManifest>
<proxyServer serverName=“127.0.0.1”
port=“8999” />
<crawler

start-url=“PATH OF FILE REPRESENTING THE SEARCH
SPACE”
isTranslog=“true”
acquireOnCacheHit=“true”
>
<!

As depicted in the exemplary code above, ‘isTranslog’ is a new attribute that is added. In an embodiment of the invention, the value of isTranslog is true if the file referenced by the start-url is a transaction log file.

In an embodiment of the invention, AcquireOnCacheHit is an attribute that is used by content acquirer 106 to acquire the content from cache file system 112 when the request is a cache hit. In an embodiment of the invention, content acquirer 106 reads AcquireOnCacheHit attribute, and sends a custom HTTP header if the value of the attribute is true. In an exemplary embodiment of the invention, HTTP header has the form:
GET http://abcd.com/efgh.html HTTP/1.0
X-If-Cache-Hit: true
The HTTP header can be used by caching proxy 110 to determine if it has to go outside content engine 102 to fetch the content. In an embodiment of the invention, this can be used to preposition only the content that is cached in content engine 102.

In accordance with another embodiment of the invention, multiple caching proxies can be used to preposition content. Such deployments use facilities such as ICP, and healing mode in caching proxy 110 to fetch content from other CEs in the CDN.

In accordance with an embodiment of the invention, the transaction logging export feature can be used to export the transaction logs from content engine 102 to a remote server. In accordance with an embodiment of the invention, the CEs in CDN 100 are configured to use content engine 102 as the remote server. This can enable all the CEs in a webcache farm to export their transaction logs to content engine 102. Content acquirer 106 can process these transaction log files and form the search space.

Embodiments of the present invention have the advantage that acquisition and storage of the content, selected on the basis of a predefined criterion, is performed based on the CEs cache file system. Further, embodiments of the invention provide methods for prepositioning the stored content. This method can be deployed throughout the CDN, for example, by a dedicated network of servers and the Internet, and by web publishers, to distribute their content on a subscription basis to their users. The embodiments of the invention also provide methods and systems to increase the caching efficiency and bandwidth over the network by storing and distributing selected content over the CDN. This is advantageous for the distribution of content over CDNs comprising servers at different geographical locations. The difference in the time zone between these servers can be used to push the selected content from one server to another at a different geographical location. This helps to improve bandwidth utilization at the second server. The selected content can be pushed, based on predefined criteria.

Although the invention has been discussed with respect to the specific embodiments thereof, these are merely illustrative and not restrictive of the invention. For example, a ‘method for distribution of content in a network’ can include any type of analysis, manual or automatic, to anticipate the requirements of distribution of content.

Although specific protocols have been used to describe embodiments, other embodiments can use other transmission protocols or standards. Use of the terms ‘peer’, ‘client’, and ‘server’ can include any type of device, operation, or other process. The present invention can operate between any two processes or entities including users, devices, functional systems, or combinations of hardware and software. Peer-to-peer networks and any other networks or systems where the roles of client and server are switched, change dynamically, or are not even present, are within the scope of the invention.

Any suitable programming language can be used to implement the routines of the present invention including C, C++, Java, assembly language, etc. Different programming techniques such as procedural or object oriented can be employed. The routines can execute on a single processing device or multiple processors. Although the steps, operations, or computations may be presented in a specific order, this order may be changed in different embodiments. In some embodiments, multiple steps shown sequentially in this specification can be performed at the same time. The sequence of operations described herein can be interrupted, suspended, or otherwise controlled by another process, such as an operating system, kernel, etc. The routines can operate in an operating system environment or as stand-alone routines occupying all, or a substantial part, of the system processing.

In the description herein for embodiments of the present invention, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

Also in the description herein for embodiments of the present invention, a portion of the disclosure recited in the specification contains material, which is subject to copyright protection. Computer program source code, object code, instructions, text or other functional information that is executable by a machine may be included in an appendix, tables, figures or in other forms. The copyright owner has no objection to the facsimile reproduction of the specification as filed in the Patent and Trademark Office. Otherwise all copyright rights are reserved.

A ‘computer’ for purposes of embodiments of the present invention may include any processor-containing device, such as a mainframe computer, personal computer, laptop, notebook, microcomputer, server, personal data manager or ‘PIM’ (also referred to as a personal information manager), smart cellular or other phone, so-called smart card, set-top box, or any of the like. A ‘computer program’ may include any suitable locally or remotely executable program or sequence of coded instructions, which are to be inserted into a computer, well known to those skilled in the art. Stated more specifically, a computer program includes an organized list of instructions that, when executed, causes the computer to behave in a predetermined manner. A computer program contains a list of ingredients (called variables) and a list of directions (called statements) that tell the computer what to do with the variables. The variables may represent numeric data, text, audio or graphical images.

A ‘computer readable medium’ for purposes of embodiments of the present invention may be any medium that can contain, store, communicate, propagate, or transport the computer program for use by or in connection with the instruction execution system apparatus, system or device. The computer readable medium can be, by way of example only but not by limitation, an electronic, magnetic, optical, electromagnetic, infrared, or semiconductor system, apparatus, system, device, propagation medium, or computer memory.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Further, at least some of the components of an embodiment of the invention may be implemented by using a programmed general-purpose digital computer, by using application specific integrated circuits, programmable logic devices, or field programmable gate arrays, or by using a network of interconnected components and circuits. Connections may be wired, wireless, by modem, and the like.

It will also be appreciated that one or more of the elements depicted in the drawings/figures can also be implemented in a more separated or integrated manner, or even removed or rendered as inoperable in certain cases, as is useful in accordance with a particular application.

Additionally, any signal arrows in the drawings/Figures should be considered only as exemplary, and not limiting, unless otherwise specifically noted. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims

What is claimed is:

1. A method for distribution of content in a network, the network comprising content engines, the method comprising:
selecting a list of contents to be acquired based on a predetermined criterion; acquiring each of the content from the selected list of contents from one or more cache file systems;
storing the acquired content; and
sending the content to the content engines to make the stored content available on the network.

2. The method of claim 1, wherein the network comprises a content delivery network.

3. The method of claim 1, wherein the predetermined criterion for selecting a list of contents is one or more from a group comprising the frequency of accessing the content in the network, the size of the content, the type of the content, and the time lapsed since last modification of the content.

4. The method of claim 1, wherein acquiring each of the content from the selected list of contents from one or more cache file systems comprises:
sending a request for the content to one or more caching proxies; forwarding the request for the content from one or more caching proxies to one or more cache file systems;
receiving the content from one or more cache file systems; and
serving the received content for acquisition.

5. The method of claim 1, wherein the acquired content is stored in a persistent content delivery network file system storage.

6. The method of claim 1, wherein the content is sent to the content engines in the network using Internet Protocol Multicast.

7. The method of claim 1, wherein the content is sent to the content engines in the network using secure Transmission Control Protocol.

8. A system for distribution of content in a network, the network comprising content engines, the system comprising:
means for selecting a list of contents to be acquired based on a predetermined criterion; means for acquiring each of the content from the selected list of contents from one or more cache file systems;
means for storing the acquired content; and
means for sending the content to the content engines to make the stored content available on the network.

9. A system for distribution of content in a network, the network comprising content engines, the system comprising:
a content acquirer for selecting a list of contents to be acquired based on a predetermined criterion;
at least one caching proxy for acquiring each of the content from the selected list of contents from one or more cache file systems;
a storage unit for storing the acquired content; and
a content distributor for sending the content to the content engines to make the stored content available on the network.

10. The system of claim 9, wherein the network comprises a content delivery network.

11. The system of claim 9, wherein the predetermined criterion for selecting a list of contents is one or more from a group comprising the frequency of accessing the content in the network, the size of the content, the type of the content, and the time lapsed since last modification of the content.

12. The system of claim 9, wherein the storage unit for storing the acquired content comprises a persistent content delivery network file system storage.

13. The system of claim 9, wherein the content distributor sends the content to the content engines in the network using Internet Protocol Multicast.

14. The system of claim 9, wherein the content distributor sends the content to the content engines in the network using secure Transmission Control Protocol.

15. The system of claim 9 wherein the content engine comprises an Application and Content Networking Software.

16. The system of claim 9, wherein the content is acquired from the one or more caching proxy by using a Hyper Text Transport Protocol (HTTP).

17. The system of claim 9, wherein the caching file system comprises a circular file system.

18. The system of claim 11, wherein the frequency of access is determined based on one of transaction logs and Internet caching protocol with a caching proxy.

19. An apparatus for distribution of content in a network, the network comprising content engines, the apparatus comprising:
a processing system including a processor coupled to a display and user input device; and
a machine-readable medium including instructions executable by the processor comprising:
one or more instructions for selecting a list of contents to be acquired based on a predetermined criterion;
one or more instructions for acquiring each of the content from the selected list of contents from one or more cache file systems;
one or more instructions for storing the acquired content; and
one or more instructions for sending the content to the content engines to make the stored content available on the network.

20. A machine-readable medium including instructions executable by a processor for distribution of content in a network, the network comprising content engines, the machine-readable medium comprising:
one or more instructions for selecting a list of contents to be acquired based on a predetermined criterion;
one or more instructions for acquiring each of the content from the selected list of contents from one or more cache file systems;
one or more instructions for storing the acquired content; and
one or more instructions for sending the content to the content engines to make the stored content available on the network.
